(19) United States
(12) Patent Application Publication
(10) Pub. No.: US 2021/0292649 A1
(43) Pub. Date: Sep. 23, 2021

(54) COMPOSITION

(71) Applicant: SI GROUP SWITZERLAND (CHAA) GMBH, Pratteln (CH)

(72) Inventors: Jonathan HILL, Manchester (GB); Maurice POWER, Manchester (GB); Ian HOWELLS, Meltham (GB); David Steven BRASSINGTON, Hyde (GB)

(21) Appl. No.: 17/262,417

(22) PCT Filed: Jul. 25, 2019
(86) PCT No.: PCT/EP2019/070120

§ 371 Date: Jan. 22, 2021

(30) Foreign Application Priority Data
Jul. 25, 2018 (GB) 1812145.9

(51) Int. Cl. C09K 15/20; C07F 9/145; C09K 15/08; C09K 15/02; C08K 5/526

(52) U.S. Cl. CPC C09K 15/20; C07F 9/145; C08K 5/526; C09K 15/02; C09K 15/08

(57) ABSTRACT

The present invention concerns a stabilising antioxidative composition comprising tris(2-t-butylphenyl) phosphite in the absence of tris(2,4-di-t-butylphenyl) phosphite.

The present invention relates to stabilising phosphite-based antioxidative compositions for polymers.

Phosphites are used as processing stabilisers in polymers in multiple applications where the phosphite and associated degradation products can be extracted and lead to human exposure (e.g. in food packaging and drinking water pipes).

Recent attention by regulatory authorities has focussed on the degradation products, often referred to as non-intentionally added substances (NIAS). Since phosphites are hydrolytically labile (even those more hydrolysis-resistant phosphites) they will hydrolyse to a degree thus forming the respective alkylated phenol building blocks as degradation products. They will also oxidise to phosphates during the course of antioxidant protection. In particular, concern has been raised on the alkylated phenol building blocks with several of these materials now included on the EU substance of very high concern list or under scrutiny through the EU community rolling action plan (CoRAP). All those under review that have had concerns raised against them have one commonality in that they are all substituted in the para position on the phenolic ring.

Sumpter et al (E. J. Routledge, J. P. Sumpter, J. Biol. Chem. 1997, 272, 3280-3288) published an in vitro assay in 1997 which clearly showed that para substituted alkylphenols exhibit estrogenic (endocrine-disrupting) effects in the assay whilst the corresponding ortho and meta substituted species show no effects. Since most common phosphite anti-oxidants placed on the market today are derived from phenols which have at least one substituent in the para position on the phenolic ring then it opens the possibility of future regulatory action on the degradants occurring.

A suitable alternative to para-substituted alkaryl phosphites, preferably an alternative having improved performance, would be desirable. Tris(2-t-butylphenyl) phosphite (TOTBP) (CAS 31502-36-0) has been identified by the inventors of the present invention as such an improved alternative.

Hereinafter tris(2-t-butylphenyl) phosphite (CAS 31502-36-0) will also be referred to as TOTBP.

TOTBP has a higher phosphorus content per gram of material (6.5%) than the industry standard para-substituted alkaryl phosphite, tris(2,4-t-butylphenyl) phosphite sold by SI GROUP™ (previously Addivant™) under the tradename ALKANOX™ 240 (4.8%) and consequently in principle may be used at a lower loading (up to about 25% lower) than such industry standard materials with equivalent antioxidative effect. Alternatively, superior polymer protection can be achieved when used at equal loading.

2-t-butyl phenol (2TBP, the precursor to TOTBP) does not have the same concerns on endocrine disruption effects as para-substituted butylphenols and is deemed to be a safer material for use.

TOTBP is disclosed in the art in the following terms.

EP 0026893 (counterpart DE 2490548) discloses a process for preparing crystalline TOTBP. The preparation involves the treatment of 2-t-butyl phenol with PCl₃, followed by degas and distillation to remove excess phenol, and finally crystallisation and recrystallisation from a liquid alcohol to give colourless crystals (m.pt 72° C.).

GB 2227490 discloses the preparation of many phosphite additives, including TOTBP. Preparation is by treatment of 2-t-butyl phenol with PCl₃ in the presence of aluminium trichloride under intense stirring for 6 hours at 72-74° C. This is followed by distillation to remove excess PCl₃, and purification to give a yellow clear product which is said to have solidified at room temperature to give a glass-like solid product.

EP 0211663 discloses a stabilised polyolefin resin composition containing a phenolic compound and a phosphite compound which may be TOTBP. Many other phosphites are disclosed and the use of TOTBP is not exemplified.

EP 281189 and U.S. Pat. No. 4,957,956 relate to a solid stabilizer composition for synthetic polymers, the process for its preparation and its use in the stabilization of synthetic polymers. Many phosphites including TOTBP and A240 are mentioned. EP 278579 constitutes a similar disclosure.

EP 1151034 and US 2005/0113494, EP 1885787 and U.S. Pat. No. 7,135,511 disclose the use of a polyolefin combined with an arylalkylphosphite with a triarylphosphite and additional additives such as hindered phenols. TOTBP is mentioned amongst many as a suitable triarylphosphite.

EP 2459575, US 2003/0158306 and U.S. Pat. No. 7,135,511 disclose a liquid phosphite composition combined with an ethanolamine based amine of varying structure. The phosphite component comprises at least 2 phosphites. One of these may be TOTBP.

U.S. Pat. Nos. 4,187,212 and 4,290,941 refer to TOTBP amongst many phosphites in combination with a hindered phenol in PP or PE.

U.S. Pat. No. 4,348,308 discloses the use of stabiliser compositions including phosphites in PVC. A mentioned embodiment includes TOTBP but many of the disclosed compounds are 2-tert-butylphenyl compounds bearing a para (4-) tertiary butyl group.

U.S. Pat. No. 4,360,617 discloses TOTBP as being suitable for combination with a phenolic component to stabilise various polymers excluding PE and PP but the disclosure emphasises phosphites having a 4-position substituent.

U.S. Pat. No. 4,829,112 discloses the combined use of hindered phenols derived from the reaction of dihydric alcohols with PP-BASE and a phosphite. TOTBP is specifically claimed as a suitable phosphite.

U.S. Pat. No. 5,487,856 discloses the use of TOTBP in the formation of a spinnable polyamide mixture by melt-mixing a fibre forming polyamide in addition to end group increasing amines/alcohols and water or mixtures thereof.

U.S. Pat. No. 8,048,946 discloses a composition comprising a mixture of phosphites which is a liquid at RT and an alkanolamine. TOTBP is named within the group of phosphites that may be selected.

U.S. Pat. No. 8,258,214 discloses a PE film stabilised with a mixture of two phosphites, one of which may be TOTBP.

U.S. Pat. No. 4,282,141 discloses the use of an additive composition for PVC comprising a diketone metal salt with an organic phosphite. TOTBP is included in the general description of what the phosphite may be. The general formula is included in the claims, but not specifically TOTBP.

GB 2227490 discloses stabilisers for polymeric substrates having a general formula which encompasses TOTBP.

U.S. Pat. No. 6,051,671 relates to a stabilization package can comprise fillers, heat and light stabilizers, pigments and colours and nucleating agents. The secondary antioxidants are generally organophosphites, including triaryl phosphites, of which TOTBP is a named example.

EP 254348 discloses a process for preparing polymers or copolymers of thermostabilized α-olefins which comprises carrying out the polymerization in the presence of an antioxidant selected from organic phosphites, diphosphites, phosphonites and diphosphonites, including aryl phosphites having a general formula encompassing TOTBP, which is specifically named in the claims.

GB 2156360 disclose a transparent radiation-stable polypropylene resin composition which comprises a) a polypropylene resin; b) a sorbitol derivative; c) a specific phosphite compound; and d) a polyamine compound. The phosphite compound c) can be TOTBP.

U.S. Pat. No. 7,468,410 discloses a process for stabilizing a polyolefin comprising incorporating or applying to said polyolefin an effective stabilizing amount of a mixture of at least two different tris-(mono-alkyl) phenyl phosphite esters of a formula which encompasses TOTBP.

It will be seen that TOTBP is disclosed widely in the art as a polymer stabiliser but always in conjunction with many other and varied phosphites, often including para-substituted alkyaryl phosphites. It has never been recognised in the art as being any more or less suitable than any other of the many organic phosphites commonly disclosed for antioxidative purposes. It has a relatively low melting point (72° C.) with attendant handling difficulties. It is manufactured in common with other organic phosphites by combining an alkylated phenolic starting material with phosphorus trichloride, specifically by adding the phosphorus trichloride to the alkylated phenolic starting material, a reaction which commonly results in some undesirable dealkylation and so for a variety of reasons has not therefore been widely investigated.

Consequently, this invention concerns the selection of TOTBP as a specifically suitable and improved alternative to para-substituted alkaryl phosphites. The inventors of the present invention have also found synergistic effects between TOTBP and certain other additives and have recognised means of preparing and providing TOTBP with minimal debutylation.

According to the present invention there is provided a stabilising antioxidative composition comprising tris(2-t-butylphenyl) phosphite in the absence of tris(2,4-di-t-butylphenyl) phosphite.

The stabilising antioxidative composition may be absent of any arylphosphite having a t-butyl group in the para-position with respect to the phosphite group.

The stabilising antioxidative composition may be absent of any arylphosphite having an alkyl group in the para-position with respect to the phosphite group.

It should be understood that for all further aspects of the invention, the stabilising antioxidative composition may be absent of tris(2,4-di-t-butylphenyl) phosphite, absent of any arylphosphite having a t-butyl group in the para-position with respect to the phosphite group and/or absent of any arylphosphite having an alkyl group in the para-position with respect to the phosphite group.

As well as seeking to avoid the presence in an antioxidative stabilising composition of arylphosphites having alkyl groups in the para-position with respect to the phosphite group, this invention is also concerned with avoiding the presence in an antioxidative stabilising composition of dealkylated, particularly debutylated arylphosphites because of the risk of generating unwanted phenol as an antioxidative by-product during the course of use of the stabilising composition.

According to another aspect of the invention there is provided a stabilising antioxidative composition comprising tris(2-t-butylphenyl) phosphite in the absence of any di(2-t-butylphenyl) monophenyl phosphite.

Di(2-t-butylphenyl) monophenyl phosphite may arise through debutylation in the preparation of TOTBP, resulting in the unwanted generation of phenol (as well as t-butyl chloride side product). Phenol will then react with PCl₃ and 2TBP to generate di(2-t-butylphenyl) monophenyl phosphite as reaction by-product.

This aspect of the invention therefore further concerns a product-by-process, namely a stabilising antioxidative composition comprising tris(2-t-butylphenyl) phosphite in the absence of any di(2-t-butylphenyl) monophenyl phosphite obtainable or obtained by adding 2-t-butyl phenol to a phosphorus trihalide (preferably phosphorus trichloride).

The inventors of the present invention have surprisingly found that by adding 2-t-butyl phenol to the phosphorus trihalide as opposed to the standard practice of adding the phosphorous trihalide to 2-t-butyl phenol (i.e. a reverse addition as opposed to a standard addition), a high purity TOTBP product can be obtained. The addition of 2-t-butyl phenol to the phosphorus trihalide has not previously been contemplated, likely due to safety concerns and the complexity of such an addition.

Thus, according to a further aspect of the invention there is provided a product-by-process, namely a stabilising antioxidative composition comprising tris(2-t-butylphenyl) phosphite obtainable or obtained by adding 2-t-butyl phenol to a phosphorus trihalide.

According to a further aspect of the invention there is provided a process for forming tris(2-t-butylphenyl) phosphite, comprising adding 2-t-butyl phenol to a phosphorus trihalide.

The phosphorus trihalide may be phosphorus trichloride (PCl₃).

The 2-t-butyl phenol may be added to the phosphorus trihalide by subsurface addition. Subsurface addition is used as a means of ensuring that the 2-t-butyl phenol is distributed uniformly within the phosphorus trihalide as the addition proceeds. This method of addition advantageously prevents the unwanted debutylation of 2-t-butyl phenol to phenol and, as a result, the loss of t-butyl chloride to the atmosphere.

The addition of 2-t-butyl phenol to the phosphorus trihalide may be conducted stepwise or continuously such that 2-t-butyl phenol is gradually added to a bulk quantity of the phosphorus trihalide.

The reaction temperature during addition of 2-t-butyl phenol to the phosphorus trihalide may be maintained at or below 150° C., at or below 125° C., at or below 100° C., or at or below 75° C., for at least a portion of the period of time during which the 2-t-butyl phenol is added to the phosphorus trihalide.

The term “for at least a portion of the period” may mean at least 10%, at least 25%, or at least 50% of the period of time during which the 2-t-butyl phenol is added to the phosphorus trihalide.

The reaction temperature during addition of 2-t-butyl phenol to the phosphorus trihalide may be maintained at or below 150° C., at or below 125° C., at or below 100° C., or at or below 75° C. for some or all, preferably all, of the initial stages of addition of 2-t-butyl phenol to the phosphorus trihalide. The term “initial stages” may mean the first 10%, the first 25%, or the first 50% of the period of time over which the 2-t-butyl phenol is added to the phosphorus trihalide.

The addition of 2-t-butyl phenol to the phosphorus trihalide may be conducted in the presence of a catalyst.

The addition of 2-t-butyl phenol to the phosphorus trihalide may be conducted in the presence of a catalyst having the formula NR₁R₂R₃ wherein R₁ is H or an optionally substituted hydrocarbyl group and R₂ and R₃, which may be the same or different, are both optionally substituted hydrocarbyl groups of carbon chain length >1, >2, >3, >4, >5, >6, >7, or 8. The hydrocarbyl groups may (each, any or all of them) be alkyl groups. The catalyst may be N,N-di-octylamine.

Additionally or alternatively, the addition of 2-t-butyl phenol to the phosphorus trihalide may be conducted in the presence of a catalyst having a cation and an anion, the cation having the formula N+R₁R₂R₃R₄ wherein R₁ to R₄, which may be the same or different, are optionally substituted hydrocarbyl groups having >1, >2, >3 or 4 carbon atoms. The hydrocarbyl groups may (each, any or all of them) be alkyl groups. The catalyst may be tetrabutylammonium chloride.

The inventors of the present invention have surprisingly found that by adding 2-t-butyl phenol to the phosphorus trihalide in the presence of a catalyst, a high yield and high purity TOTBP product can be obtained.

Following addition of 2-t-butyl phenol to the phosphorus trihalide, the tris(2-t-butylphenyl) phosphite product may be obtained from a single crystallisation.

Crystallisation may be carried out using an alcoholic and/or a ketonic solvent.

The alcoholic solvent may be isopropanol.

The ketonic solvent may be methyl ethyl ketone.

Advantageously, the inventors of the present invention have found that a high purity TOTBP product, which may be absent of di(2-t-butylphenyl) monophenyl phosphite, can be obtained from a single crystallisation. No recrystallisation is required, unlike many of the prior art processes.

According to a further aspect of the invention there is provided substantially pure tris(2-t-butylphenyl) phosphite.

By “substantially pure” it is meant the tris(2-t-butylphenyl) phosphite has a purity of at least about 98%, at least about 98.5%, at least about 99%, or at least about 99.5%.

The substantially pure tris(2-t-butylphenyl) phosphite may be produced by a single chemical reaction followed by a single crystallisation.

Here, the single chemical reaction comprises adding 2-t-butyl phenol to a phosphorus trihalide in the manner previously described.

As outlined above, the inventors of the present invention have surprisingly found that a high purity TOTBP product can be obtained with only a single crystallisation. Prior art processes have tended to require crystallisation followed by recrystallisation, for example in DE 2490548. Even with multiple crystallisation steps, the TOTBP products of the prior art have not achieved the purity or yield realised by the present invention.

Also provided in accordance with the present invention is a stabilising antioxidative composition comprising the substantially pure tris(2-t-butylphenyl) phosphite as previously described.

As well as relating to a product-by-process, the invention also concerns the process itself and the foregoing paragraphs should be construed accordingly.

In all of the foregoing paragraphs by “in the absence of” or “absent of” it is meant present, if at all, only at de minimis levels.

By “de minimis” it is meant below the level at which the absent compound would make a significant contribution to the phosphorus loading of the stabilising antioxidative composition.

By “below the level at which the absent compound would make a significant contribution to the phosphorus loading” it is meant contributing below 20% by weight, below 10% by weight, below 5% by weight, below 2% by weight, below 1% by weight, or about 0% or 0% by weight of the total phosphorus present in the stabilising antioxidative composition.

Also provided is a stabilised polymeric composition comprising a polymer and a stabilising antioxidative composition according to the foregoing description.

A stabilised article manufactured from the above stabilised polymeric composition is also provided.

Further provided in accordance with the present invention is an antidegradant blend comprising a stabilising antioxidative composition according to the foregoing description.

The antidegradant blend may additionally comprise one or more of:
i. a phenolic antioxidant;
ii. a further organic phosphite antioxidant other than:
   x) tris(2,4-di-t-butylphenyl) phosphite;
   y) any arylphosphite having a t-butyl group in the para-position with respect to the phosphite group; and/or
   z) any arylphosphite having an alkyl group in the para-position with respect to the phosphite group;
iii. a sulphur-containing antioxidant; and
iv. an aminic antioxidant.

The antidegradant blend of the invention may also or alternatively comprise at least one buffering agent or acid scavenger selected from one or more of the following:
v. a buffering agent having the capacity to buffer in aqueous solution at a pH range from 4 to 8;
vi. a metal carboxylate;
vii. an inorganic antioxidant or reducing agent
viii. an inorganic acid scavenger.

The presence in the antidegradant blend of a buffering agent having the capacity to buffer in aqueous solution at a pH range from 4 to 8, of a metal carboxylate, and/or of an inorganic antioxidant or reducing agent or an inorganic acid scavenger may produce a synergistic effect with respect to the colour stability of a variety of polymers. More specifically, such a combination in the antidegradant blend may cause a significant reduction in colour formation.

Overall, the antidegradant blend of the present invention significantly improves the heat aging performance of a variety of polymers, particularly with regards to colour stability, even during prolonged or repeated heat exposure. In addition, it has been found that the antidegradant blend of the present invention improves retention of melt flow properties and viscosity of a variety of polymers, even during prolonged or repeated heat exposure. Melt flow properties can be determined using the ASTM D1238 test method.

The improved colour stability and retention of melt flow properties and viscosity during prolonged exposure to heat is advantageous since polymers are often kept in a molten state for prolonged periods of time during production and prior to use in an application.

The term ‘prolonged heat exposure’ may mean exposure to a temperature of at least about 100° C., at least about 110° C., at least about 120° C., at least about 130° C., at least about 140° C., at least about 150° C., at least about 160° C., at least about 170° C., at least about 180° C., at least about 190° C., at least about 200° C., at least about 210° C., at least about 220° C., at least about 230° C., at least about 240° C. or at least about 250° C., for at least about 1 hour, at least about 2 hours, at least about 4 hours, at least about 6 hours, at least about 12 hours, at least about 24 hours, at least about 36 hours, at least about 48 hours, at least about 3 days, at least about 4 days, at least about 5 days, at least about 6 days, at least about 7 days, at least about 10 days or at least about 14 days.

The term ‘repeated heat exposure’ may mean exposure to a temperature of at least about 100° C., at least about 150° C., at least about 200° C., at least about 250° C., or at least about 300° C., on more than one occasion, for at least about 5 seconds, at least about 10 seconds, at least about 20 seconds, at least about 30 seconds, at least about 1 minute, at least about 5 minutes, or at least about 10 minutes. Repeated heat exposure may be experienced during multiple passes through an extruder.

The inventors of the present invention have unexpectedly found that buffering agents which have the capacity to buffer in aqueous solution at a pH range from 4 to 8 are advantageous.

Without wishing to be bound by any such theory, the inventors of the present invention believe that buffering agents which buffer in aqueous solution at a pH of less than 4 may promote an acidic environment which may cause autocatalytic hydrolysis of the antioxidant, particularly where the antioxidant is a phosphite antioxidant such as TOTBP. Acid scavengers which simply act to increase the pH of the composition to a pH of greater than 8, for example calcium hydroxide and potassium carbonate, may cause increased colour formation due to the interaction with the antioxidant, particularly where the antioxidant is a phenolic antioxidant.

Conversely, buffering agents of the present invention which buffer in aqueous solution at a pH range from 4 to 8 have been found not to unfavourably interact with the other antioxidants in the stabilising antioxidative composition.

The buffering agent may be a solid at ambient conditions.

In this context, by ‘ambient conditions’ it is meant a temperature of 50° C. or lower, a temperature of 40° C. or lower, a temperature of 30° C. or lower, or a temperature of 25° C. or lower, and 1 atmosphere pressure i.e. 101.325 kPa.

The buffering agent may be a solid at a temperature of 25° C. and 1 atmosphere pressure i.e. 101.325 kPa.

The inventors of the present invention have found that a solid buffering agent can be used in the stabilising antioxidative composition. This is surprising as it was previously assumed that a solid buffering agent would not be soluble in the polymer to which it was added. Hence buffering agents of the prior art tended to be used as aqueous solutions. Providing the buffering agent as a solid provides handling benefits during processing as the as the solid buffering agent can be compounded into the polymer. Dissolution in water which is immiscible with the polymer would make compounding into the polymer much more difficult or impossible.

In some instances, it may be preferable for the buffering agent to have a relatively low molecular weight, as this results in a greater relative molar quantity of buffering agent in the stabilising antioxidative composition. The buffering agent may have a molecular weight of less than about 500. The buffering agent may have a molecular weight of less than about 450, less than about 400, or less than about 350.

The buffering agent may comprise one or more metal phosphates and/or one or more metal pyrophosphates.

The metal phosphate and/or metal pyrophosphate may comprise an alkali metal phosphate or alkali metal pyrophosphate.

The alkali metal phosphate may be selected from compounds with the following formulas: MPO₄H₂, M₂PO₄H and M₃PO₄, wherein M is an alkali metal cation. The alkali metal cation ‘M’ may be selected from lithium (Li), sodium (Na), and potassium (K).

The alkali metal pyrophosphate may be selected from compounds with the following formulas: MP₂O₇H₃, M₂P₂O₇H₂, M₃P₂O₇H and M₄P₂O₇, wherein M is an alkali metal cation. The alkali metal cation ‘M’ may be selected from lithium (Li), sodium (Na), and potassium (K).

The buffering agent may comprise a mixture of two or more metal phosphates and/or metal pyrophosphates.

The buffering agent may comprise a mixture of two or more alkali metal phosphates. The buffering agent may comprise a mixture of at least one monobasic alkali metal phosphate (i.e. MPO₄H₂) and at least one dibasic alkali metal phosphate (i.e. M₂PO₄H), for example a mixture of monosodium phosphate (NaPO₄H₂) and disodium phosphate (Na₂PO₄H).

Where the buffering agent comprises a mixture of at least one monobasic alkali metal phosphate and at least one dibasic alkali metal phosphate, the weight ratio of the monobasic component to the dibasic component (MONO:DI) may be from 10:90 to 95:5, or from 10:90 to 90:10, or from 20:80 to 80:20, or from 30:70 to 70:30, or from 40:60 to 60:40. The MONO:DI ratio may be from 1:2 to 2:1, for example 1:1.

Suitable selection of combinations of buffering agents can ensure that buffering takes place in the required pH range. For example, a 1:1 mixture of monosodium phosphate (NaPO₄H₂) and disodium phosphate (Na₂PO₄H) will buffer at a pH of about 7.2.

Additionally or alternatively, the buffering agent may comprise one or more amino acids and/or the alkali metal salts thereof.

The amino acid and/or the alkali metal salt thereof may be naturally derived or synthetically derived. The amino acid and/or the alkali metal salt thereof may comprise glycine, cysteine, cystine, methionine, tyrosine, histidine, arginine and/or glutamic acid.

The amino acid alkali metal salt may be monosodium glutamate.

The buffering agent may be present in an amount of from about 1% to about 50% by weight of the stabilising antioxidative composition, for example from about 1% to about 40% by weight of the stabilising antioxidative composition, from about 1% to about 30% by weight of the stabilising antioxidative composition, or from about 1% to about 20% by weight of the stabilising antioxidative composition. The buffering agent may be present in an amount of from about 5% to about 15% by weight of the stabilising antioxidative composition, for example in an amount of from about 8% to about 12% by weight of the stabilising antioxidative composition.

The antidegradant blend of the invention may alternatively or additionally comprise a metal carboxylate, for example a metal stearate, a metal lactate and/or a metal benzoate. The metal carboxylate may comprise a metal stearate.

The metal stearate may comprise calcium stearate, zinc stearate, aluminium stearate, magnesium stearate, sodium stearate, cadmium stearate, barium stearate and/or a mixture of two or more thereof. The metal stearate may comprise calcium stearate.

The metal lactate may comprise sodium lactate, magnesium lactate, calcium lactate, zinc lactate and/or a mixture of two or more thereof.

The metal benzoate may comprise sodium benzoate, magnesium benzoate, calcium benzoate, zinc benzoate and/or a mixture of two or more thereof.

The metal carboxylate, for example the metal stearate, may be present in an amount of from about 1% to about 50% by weight of the antidegradant blend, from about 1 to about 40% by weight of the antidegradant blend, or from about 1% to about 30% by weight of the antidegradant blend. The metal carboxylate, for example the metal stearate, may be present in an amount of from about 5% to about 30% by weight of the antidegradant blend, or from about 10% to about 20% by weight of the antidegradant blend.

The antidegradant blend of the invention may alternatively or additionally comprise a secondary inorganic antioxidant.

The secondary inorganic antioxidant may comprise one or more of a metal hypophosphite, a metal thiosulphate, a metal bisulphite, a metal metabisulphite and/or a metal hydrosulphite.

The metal of the hypophosphite, thiosulphate, bisulphite, metabisulphite and/or hydrosulphite may be an alkali metal and/or an alkaline earth metal. The alkali metal may be selected from lithium (Li), sodium (Na), and potassium (K). The alkaline earth metal may be selected from calcium (Ca) and magnesium (Mg).

The metal hypophosphite may be selected from compounds with the formula: MPO₂H₂. The metal thiosulphate may be selected from compounds with the formula: M₂S₂O₃. The metal bisulphite may be selected from compounds with the formula: MHSO₃. The metal metabisulphite may be selected from compounds with the formula: M₂S₂O₅. The metal hydrosulphite may be selected from compounds with the formula: M₂S₂O₄. In each case, M is an alkali metal cation. The alkali metal cation may be selected from lithium (Li), sodium (Na), and potassium (K).

The metal hypophosphite may be in anhydrous form i.e. an anhydrous metal hypophosphite. Alternatively, the metal hypophosphite may be in hydrated form i.e. a hydrated metal hypophosphite, for example a monohydrate metal hypophosphite. As well as hypophosphites there may also be mentioned as being suitable for use in the invention thiosulphates, bisulphites, metabisulphites and hydrosulphites. These may all be provided as for example metal salts such as alkali metal salts. As with metal hypophosphites these may be provided in anhydrous form or as hydrates. For example, penta-hydrates of thiosulphate and dihydrates of hydrosulphite may be mentioned and other suitable materials may be apparent to the skilled addressee.

The secondary inorganic antioxidant may comprise sodium hypophosphite.

Inorganic phosphites, for example metal hypophosphites, are generally considered to have poor mobility/solubility in polymers. However, the inventors of the present invention have surprisingly found that the mobility/solubility of the inorganic phosphite is greatly enhanced when an antioxidant stabilising antioxidative composition in accordance with the invention (essentially comprising TOTBP) is present in the antidegradant blend. Without wishing to be bound by any such theory, the inventors of the present invention believe that there is an interaction effect between the organic phosphite antioxidant and the inorganic phosphite such that as the organic phosphite antioxidant hydrolyses it aids dissolution of the inorganic phosphite in the polymer.

The inventors of the present invention have surprisingly found that an antidegradant blend with a hydrated metal hypophosphite, for example a monohydrate metal hypophosphite, performs comparably to, and in some instances better than, a stabilising antioxidative composition with the anhydrous form of the metal hypophosphite at the same phosphorous loading, particularly with respect to the colour stability and/or melt flow properties of the polymer to which the stabilising antioxidative composition is added.

It may be advantageous to use the hydrated form of the metal hypophosphite as it tends to be cheaper than the anhydrous form.

In addition, it has unexpectedly been found that using the hydrated form of the metal hypophosphite may result in better performance with respect to colour stability of the polymer to which the stabilising antioxidative composition is added.

Without wishing to be bound by any such theory, it is believed that water molecules present in the hydrated form of the metal hypophosphite may partially hydrolyse the phosphite antioxidant and consequently reduce discolouration in the polymer.

The secondary inorganic antioxidant may be present in an amount of from about 1% to about 50% by weight of the antidegradant blend, from about 1% to about 40% by weight of the antidegradant blend, or from about 1% to about 30% by weight of the antidegradant blend. The secondary inorganic antioxidant may be present in an amount of from about 2% to about 20% by weight of the antidegradant blend, or from about 5% to about 15% by weight of the antidegradant blend.

The antidegradant blend of the invention may comprise both a buffering agent having the capacity to buffer in aqueous solution at a pH range from 4 to 8 and a secondary inorganic antioxidant. In that case the weight ratio of the buffering agent to the secondary inorganic antioxidant may be from 5:95 to 95:5, or from 10:90 to 90:10, or from 20:80 to 80:20, or from 30:70 to 70:30, or from 40:60 to 60:40. The weight ratio of the buffering agent to the secondary inorganic antioxidant may be from 1:2 to 2:1, for example 1:1.

The secondary inorganic antioxidant may comprise a metal hypophosphite and be used in conjunction with a buffering agent comprising one or more metal phosphates and/or metal pyrophosphates.

The antidegradant blend of the invention may alternatively or additionally comprise an inorganic acid scavenger such as metal oxides, metal hydroxides, metal carbonates, metal carboxylates, metal salts and hydrotalcite-like compounds such as hydrotalcite itself.

Unless otherwise indicated herein, all compounds designated by tradenames and/or CAS numbers are available from SI Group USA (USAA), LLC, 4 Mountainview Terrace, Suite 200, Danbury, Conn. 06810.

Any organic phosphite antioxidant other than TOTBP in the stabilising antioxidative composition of the invention may comprise, for example, distearylpentaerythritol diphosphite (WESTON™ 618—CAS 3806-34-6); tris(dipropyleneglycol) phosphite, C₁₈H₃₉O₉P (WESTON™ 430—CAS 36788-39-3); poly(dipropyleneglycol) phenyl phosphite (WESTON™ DHOP—CAS 80584-86-7); diphenyl isodecyl phosphite, C₂₂H₃₁O₃P (WESTON™ DPDP—CAS 26544-23-0); phenyl diisodecyl phosphite (WESTON™ PDDP—CAS 25550-98-5); heptakis (dipropyleneglycol) triphosphite (WESTON™ PTP—CAS 13474-96-9); and/or compatible mixtures of two or more thereof.

The organic phosphite antioxidant (including or consisting of TOTBP) may be present in an amount of from about 20% to about 90% by weight of the antidegradant blend, from about 30% to about 80% by weight of the antidegradant blend, or from about 40% to about 70% by weight of the antidegradant blend. The organic phosphite antioxidant may be present in an amount of from about 40% to about 60% by weight of the antidegradant blend, or from about 45% to about 60% by weight of the antidegradant blend.

The stabilising antioxidative composition in accordance with the invention may additionally comprise at least one fully hindered phenolic antioxidant, at least one low-hindered phenolic antioxidant and/or non-hindered phenolic antioxidant.

In this specification by “fully hindered” it is preferably meant that the phenolic antioxidant comprises substituent hydrocarbyl groups on both positions ortho to the phenolic —OH group, each of those substituent groups being branched at the C₁ and/or C₂ position, preferably at the C₁ position, with respect to the aromatic ring.

In this specification by “partially hindered” it is preferably meant that the phenolic antioxidant comprises at least one substituent hydrocarbyl group ortho to the phenolic —OH group, only one of the or each substituent group being branched at the C₁ and/or C₂ position, preferably at the C₁ position, with respect to the aromatic ring.

In this specification by “low hindered” it is preferably meant that the phenolic antioxidant comprises at least one substituent hydrocarbyl group ortho to the phenolic —OH group, none of those substituent groups being branched at the C₁ or C₂ position, preferably at the C₁ position, with respect to the aromatic ring.

In this specification by “non-hindered” it is preferably meant that the phenolic antioxidant comprises no substituent hydrocarbyl groups ortho to the phenolic —OH group.

Illustratively below is provided by way of example only representations of the types of structural unit present in the antioxidants used in the stabilising antioxidative compositions of the invention. In case it is not apparent, it is emphasised that these structures do not necessarily represent the entire chemical structure of the antioxidants used in the invention; merely of the critical structural unit embodied by the phenolic group and the ortho substituents, if any. It should be apparent that these structural units may form parts of larger compounds—so the aromatic group may for example carry one or more further substituents at the meta and/or para positions, and the ortho substituents may themselves be further substituted, and in any event are not limited to methyl, α-methyl styryl and t-butyl groups as illustrated below, and may for example comprise isopropyl groups, amyl groups or other hydrocarbyl groups including cyclic and aromatic groups, optionally substituted as explained above.

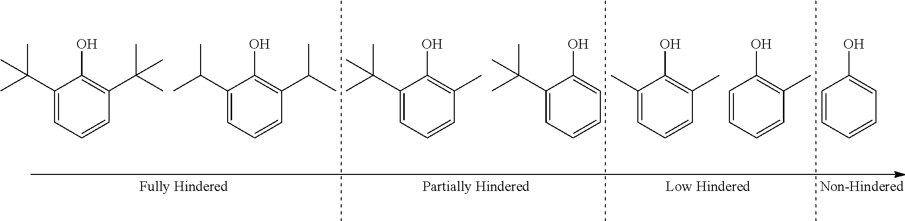

The semi-hindered phenolic antioxidant may comprise 1,3,5-tris(4-tert-butyl-3-hydroxy-2,6-dimethylbenzyl)-1,3,5-triazine-2,4,6-(1H, 3H, 5H)-trione (LOWINOX™ 1790—CAS 40601-76-1); triethyleneglycol-bis-[3-(3-t-butyl-4-hydroxy-5-methylphenyl)propionate] (LOWINOX™ GP45—CAS 36443-68-2); the butylated reaction product of p-cresol and dicyclopentadiene (LOWINOX™ CPL—CAS 68610-51-5); 2,2′-methylenebis(6-t-butyl-4-methylphenol) (LOWINOX™ 22M46—CAS 119-47-1); and/or compatible mixtures of two or more thereof.

The hindered phenolic antioxidant may comprise tetrakismethylene(3,5-di-t-butyl-4-hydroxyhydrocinnamate) methane (ANOX™ 20—CAS 6683-19-8); 2,2′thiodiethylene bis[3(3,5-di-t-butyl-4-hydroxyphenyl)propionate] (ANOX™ 70—CAS 41484-35-9); C13-C15 linear and branched alkyl esters of 3-(3′5′-di-t-butyl-4′-hydroxyphenyl) propionic acid (ANOX™ 1315—CAS 171090-93-0); octadecyl 3-(3′,5′-di-t-butyl-4′-hydroxyphenyl) propionate (ANOX™ PP18—CAS 2082-79-3); 1,3,5-tris(3,5-di-t-butyl-4-hydroxybenzyl) isocyanurate (ANOX™ 1014—CAS 27676-62-6); 1,3,5-trimethyl-2,4,6-tris(3,5-di-t-butyl-4-hydroxybenzyl)benzene (ANOX™ 330—CAS 1709-70-2); N,N′-hexamethylenebis[3-(3,5-di-t-butyl-4-hydroxyphenyl)propionamide] (LOWINOX™ HD98—CAS 23128-74-7); 1,2-bis(3,5-di-t-butyl-4-hydroxyhydrocinnamoyl)hydrazine (LOWINOX™ MD24—CAS 32687-78-8); C9-C11 linear and branched alkyl esters of 3-(3′,5′-di-t-butyl-4′-hydroxyphenyl)propionic acid (NAUGARD PS48™—CAS 125643-61-0); 2,2′-ethylidenebis[4,6-di-t-butylphenol] (ANOX™ 29—CAS 35958-30-6); butylated hydroxytoluene (BHT—CAS 128-37-0, available from Sigma-Aldrich); and/or compatible mixtures of two or more thereof.

The phenolic antioxidant may comprise tetrakismethylene (3,5-di-t-butyl-4-hydroxyhydrocinnamate) methane (ANOX™ 20—CAS 6683-19-8).

The phenolic antioxidant may be present in an amount of from about 1% to about 50% by weight of the stabilising antioxidative composition, for example from about 5% to about 45% by weight of the stabilising antioxidative composition, from about 10% to about 40% by weight of the stabilising antioxidative composition, or from about 15% to about 35% by weight of the stabilising antioxidative composition.

Any sulphur-containing antioxidant present in the stabilising antioxidative composition of the invention may have a sulphur group with the formula —CH₂—(S)ₓ—CH₂—, wherein x=1 or 2, and optionally wherein neither of the —CH₂— groups is directly bonded to an aromatic group.

Such stabilising components may have a greater stabilising effect compared to a stabilising antioxidative composition comprising a sulphur-containing antioxidant wherein one or both of the —CH₂— groups is directly bonded to an aromatic group, or wherein one or both of the sulphur atoms are directly bonded to an aromatic group, for example 2,4-bis-(n-octylthio)-6-(4-hydroxy-3,5-di-tert-butylanilino)-1,3,5-triazine (IRGANOX™ 565—CAS 991-84-4, available from BASF).

The sulphur-containing antioxidant may have the formula R—CH₂—(S)ₓ—CH₂—R, wherein x=1 or 2, and wherein the or each R group, which may be the same or different, is or contains, independently, an aliphatic group. Where more than one such aliphatic group is present in either or each R group, the aliphatic groups may be the same or different.

The, each or any aliphatic group may be straight chain or branched chain and may be substituted with one or more functional groups.

The sulphur-containing antioxidant may comprise one or more thioether groups and one or more ester groups.

For example, the sulphur-containing antioxidant may comprise dilauryl-3,3′-thiodipropionate (NAUGARD™ DLTDP—CAS 123-28-4); distearyl-3,3′-thiodipropionate (NAUGARD™ DSTDP—CAS 693-36-7); ditridecylthiodipropionate (NAUGARD™ DTDTDP (liquid) CAS—10595-72-9); pentaerythritol tetrakis (β-laurylthiopropionate) (NAUGARD™ 412S—CAS 29598-76-3); 2,2′thiodiethylene bis[3(3,5-di-t-butyl-4-hydroxyphenyl)propionate] (ANOX™ 70—CAS 41484-35-9); dimyristyl thiodipropionate (CYANOX™ MTDP—CAS 16545-54-3, available from Cytec); distearyl-disulfide (HOSTANOX™ SE 10—CAS 2500-88-1, available from Clariant); and/or compatible mixtures of two or more thereof.

The sulphur-containing antioxidant may comprise pentaerythritol tetrakis (β-laurylthiopropionate) (NAUGARD™ 412S—CAS 29598-76-3).

Additionally or alternatively, the sulphur-containing antioxidant may comprise one or more diphenyl thioethers, for example 4,4′-thiobis(2-tert-butyl-5-methylphenol) (LOWINOX™ TBM-6—CAS 96-69-5); and/or 2,2′-thiobis(6-t-butyl-4-methylphenol) (LOWINOX™ TBP-6—CAS 90-66-4).

The sulphur-containing antioxidant may be present in an amount of from about 1% to about 50% by weight of the stabilising antioxidative composition, for example from about 1% to about 40% by weight of the stabilising antioxidative composition, from about 1% to about 30% by weight of the stabilising antioxidative composition, or from about 1% to about 20% by weight of the stabilising antioxidative composition. The sulphur-containing antioxidant may be present in an amount of from about 5% to about 15% by weight of the stabilising antioxidative composition, for example in an amount of from about 8% to about 12% by weight of the stabilising antioxidative composition.

Any aminic antioxidant present in the stabilising antioxidative composition of the invention may comprise acetone diphenylamine (AMINOX™—CAS 68412-48-6); reaction products of diphenylamine and acetone (BLE™—CAS 112-39-4); N,N′-diphenyl-p-phenylenediamine (FLEXAMINE™—CAS 74-31-7); benzeneamine, N-phenyl-, reaction products with 2,4,4-trimethylpentene (NAUGARD™ PS30—CAS 68411-46-1); bis[4-(2-phenyl-2-propyl)phenyl]amine (NAUGARD™ 445—CAS 10081-67-1); poly(1,2-dihydro-2,2,4-trimethylquinoline) (NAUGARD™ Q—CAS 26780-96-1); dioctyldiphenylamine (OCTAMINE™—CAS 101-67-7); N,N-bis-(1,4-dimethylpentyl)-p-phenylenediamine (FLEXZONE™ 4L—CAS 3081-14-9); 1,4-benzenediamine, N,N′-mixed phenyl and tolyl derivatives (NOVAZONE™ AS—CAS 68953-84-4); N,N′,N″-tris[4-[(1,4-dimethylpentyl)amino]phenyl]-1,3,5-triazine-2,4,6-triamine (DURAZONE™ 37—CAS 121246-28-4); N-isopropyl-N′-phenyl-1,4-phenylenediamine (FLEXZONE™ 3C—CAS 101-72-4); diphenylamine (CAS 122-39-4, available from Sigma-Aldrich); (1,3-dimethylbutyl)-N′-phenyl-p-phenylenediamine (CAS 793-24-8, available from Sigma-Aldrich); poly(4-hydroxy-2,2,6,6-tetramethyl-1-piperidine ethanol-alt-1,4-butanedioic acid) (LOWILITE™ 62—CAS 65447-77-0); bis(2,2,6,6-tetramethyl-4-piperidyl) sebacate (LOWILITE™ 77—CAS 52829-07-9); bis(1,2,2,6,6-pentamethyl-4-piperidyl) sebacate (LOWILITE™ 92—CAS 41556-26-7); poly[[6-[(1,1,3,3-tetramethylbutyl)amino]-1,3,5-triazine-2,4-diyl][2,2,6,6-tetramethyl-4-piperidiyl)imino]-1,6-hexanediyl[(2,2,6,6-tetramethyl-4-piperidiyl)imino]]) (LOWILITE™ 94—CAS 70624-18-9); 1,5,8,12-tetrakis[,6-bis(N-butyl-N-1,2,2,6,6-pentamethyl-4-piperidylamino)-1,3,5-triazin-2-yl]-1,5,8,12-tetraazadodecane (LOWILITE™ 19—CAS 106990-43-6); and/or compatible mixtures of two or more thereof, for example.

Additional antioxidants, for example hydroxylamines or precursors thereof, lactone radical scavengers, acrylate radical scavengers, UV absorbers and/or chelating agents, may be included in the stabilising antioxidative composition.

The antidegradant blend may be solid at a temperature of about 50° C. or lower, a temperature of about 40° C. or lower, a temperature of about 30° C. or lower, or a temperature of about 25° C. or lower, and 1 atmosphere pressure i.e. 101.325 kPa.

The antidegradant blend may be solid at a temperature of 25° C. and 1 atmosphere pressure i.e. 101.325 kPa.

Also provided in accordance with the present invention is the use of a stabilising antioxidative composition or an antidegradant blend as hereinbefore described to stabilise a polymer.

Also provided in accordance with the present invention is the use of a stabilising antioxidative composition or an antidegradant blend as hereinbefore described to stabilise a polyolefin.

Also provided in accordance with the present invention is a stabilised polymeric composition comprising a polymer and a stabilising antioxidative composition or an antidegradant blend as hereinbefore described.

The stabilising antioxidative composition and/or the antidegradant blend may be present in the stabilised polymeric composition in an amount of from about 0.01% to about 5% by weight of the stabilised polymeric composition. The stabilising antioxidative composition and/or the antidegradant blend may be present in an amount of from about 0.01% to about 2% by weight of the stabilised polymeric composition, for example from about 0.1% to about 1.5% by weight of the stabilised polymeric composition.

The polymeric base material (i.e. the polymer) may comprise a polyolefin. The polyolefin may comprise a homopolymer of ethylene, propylene, butylene or a higher alkene. The ethylene homopolymer may comprise low density polyethylene (LDPE), linear low density polyethylene (LLDPE) and/or high density polyethylene (HDPE). The propylene homopolymer may be isotactic, syndiotactic or atactic.

Additionally or alternatively, the polyolefin may comprise a copolymer of ethylene, propylene and/or butylene. The copolymer may be a random copolymer or a block copolymer. For example, the polyolefin may comprise an ethylene/propylene block copolymer, an ethylene/propylene random copolymer, an ethylene/propylene/butylene random terpolymer or an ethylene/propylene/butylene block terpolymer.

The polyolefin may comprise ethylene and/or propylene.

Additionally or alternatively, the polymeric base material may comprise a styrenic block copolymer, for example styrene-butadiene-styrene (SBS), styrene-isoprene-styrene (SIS), styrene-ethylene/butylene-styrene (SEBS), styrene-ethylene/propylene (SEP) and styrene-butadiene rubber (SBR); or suitable mixtures and blends thereof.

Additionally or alternatively, the polymeric base material may comprise an ethylene vinyl acetate polymer, for example EVA.

Polymeric base materials such as polyurethanes, polyamides, polyesters, polycarbonates and acrylics may also be the subject of this invention.

The inventors of the present invention have surprisingly found that the antidegradant blend of the present invention, when added to a polymer, may cause the yellowness index of the polymer (measured by ASTM D1925) to rise by less than 5.5, less than 5, less than 4.5, less than 4, less than 3.5, or less than 3, over five passes through an extruder at 260° C. in air.

The antidegradant blend, when added to a polymer, may cause the melt flow rate of the polymer (measured by ASTM D1238 with a temperature of 190° C., a 2.16 kg weight and a 2.095 mm die) to rise by less than 14 g/10 min, less than 10 g/10 min, less than 8 g/10 min, less than 6 g/10 min, or less than 5 g/10 min, over five passes through an extruder at 260° C. in air.

The antidegradant blend, when added to a polymer, may cause the melt flow rate of the polymer (measured by ASTM D1238L with a temperature of 230° C., a 2.16 kg weight and a 2.095 mm die) to rise by less than 140%, by less than 120%, by less than 100%, by less than 90%, by less than 80%, by less than 60%, or by less than 40%, over five passes through an extruder at 260° C. in air.

The antidegradant blend, when added to a polymer, may cause the yellowness index of the polymer (measured by AATCC 23 at a temperature of 60° C.) to rise by less than 11, less than 10, less than 9, less than 8, less than 7, less than 6, less than 5, less than 4, or less than 3.5, over 21 days.

For the avoidance of doubt, all features relating to the stabilising antioxidative composition of the present invention and the antidegradant blend of the invention also relate, where appropriate, to the stabilised polymeric composition of the present invention and vice versa.

The invention will now be more particularly described with reference to the following non-limiting examples.

The stabilising antioxidative composition is formulated to be compatible with one or more polymeric materials to form a stabilised polymeric composition in accordance with the invention.

### EXAMPLES 1 TO 19

Table 1 shows the different components that were used in the following examples:

TABLE 1

| Shorthand | Component |
|---|---|
| DHT-4V | Magnesium aluminium hydrotalcite |
| A240 | ALKANOX ™ 240 - industry standard para-substituted |
| | alkaryl phosphite - tris(2,4-di-t-butylphenyl) phosphite |
| TOTBP | Tris(2-t-butylphenyl)phosphite |
| P1 | Tris(2-phenylphenyl)phosphite |
| P2 | Tris(2,4-di-t-amylphenyl)phosphite |
| P3 | Tris(2-t-amylphenyl)phosphite |
| P4 | Tris(2-t-butyl-4-methylphenyl)phosphite |
| P5 | Tris(2-cyclohexylphenyl)phosphite |
| P6 | Tris(2,5-di-t-butylphenyl)phosphite |
| A20 | ANOX ™ 20 - tetrakismethylene(3,5-di-t-butyl-4- |
| | hydroxyhydrocinnamate)methane |
| IC14 | ANOX ™ IC-14 - 1,3,5-tris(3,5-di-t-butyl-4-hydroxybenzyl) |
| | isocyanurate |
| PP18 | ANOX ™ PP18 - Octadecyl 3-(3,5-di-tert-butyl-4- |
| | hydroxyphenyl)propionate |
| TiPA | Triisopropanolamine |
| 152ST | Solid TOTBP with added TiPA (0.5 wt. %) |
| DVS391 | Solid TOTBP with added TiPA (1 wt. %) |
| ZnO | Zinc oxide |
| Na Hyp | Sodium hypophosphite |
| CaSt | Calcium stearate |

Polypropylene compositions were prepared by blending a polypropylene homopolymer with an additive package at loadings as shown in Tables 2 to 4. The polypropylene formulations are melt compounded in a single screw extruder at 230° C. under nitrogen. The % amounts shown in the tables are % by weight of the overall polypropylene composition.

TABLE 2

| | IC-14 | A20 | A240 | 152ST | DHT-4V | Total |
|---|---|---|---|---|---|---|
| Example | (%) | (%) | (%) | (%) | (%) | (%) |
| 1 (Comp) | 0.06 | — | 0.12 | — | 0.03 | 0.21 |
| 2 | 0.06 | — | — | 0.12 | 0.03 | 0.21 |
| 3 | 0.06 | — | — | 0.09 | 0.03 | 0.18 |
| 4 (Comp) | — | 0.06 | 0.12 | — | 0.03 | 0.21 |
| 5 | — | 0.06 | — | 0.12 | 0.03 | 0.21 |
| 6 | — | 0.06 | — | 0.09 | 0.03 | 0.18 |

Examples 1 and 4 comprise tris(2,4-di-t-butylphenyl) phosphite and are therefore comparative.

TABLE 3

| | A20 | TOTBP | P1 | P2 | P3 | P4 | P5 | P6 | CaSt | Total |
|---|---|---|---|---|---|---|---|---|---|---|
| Example | (%) | (%) | (%) | (%) | (%) | (%) | (%) | (%) | (%) | (%) |
| 7 | 0.04 | 0.08 | — | — | — | — | — | — | 0.03 | 0.15 |
| 8 (Comp) | 0.04 | — | 0.08 | — | — | — | — | — | 0.03 | 0.15 |
| 9 (Comp) | 0.04 | — | — | 0.08 | — | — | — | — | 0.03 | 0.15 |
| 10 (Comp) | 0.04 | — | — | — | 0.08 | — | — | — | 0.03 | 0.15 |
| 11 (Comp) | 0.04 | — | — | — | — | 0.08 | — | — | 0.03 | 0.15 |
| 12 (Comp) | 0.04 | — | — | — | — | — | 0.08 | — | 0.03 | 0.15 |
| 13 (Comp) | 0.04 | — | — | — | — | — | — | 0.08 | 0.03 | 0.15 |

Examples 8 to 13 comprise phosphites other than tris(2-t-butylphenyl) phosphite and are therefore comparative.

TABLE 4

| | Na Hyp | A20 | TOTBP | DHT-4V | Total |
|---|---|---|---|---|---|
| Example | (%) | (%) | (%) | (%) | (%) |
| 14 | — | 0.04 | 0.0611 | 0.018 | 0.1191 |
| 15 | 0.015 | 0.04 | 0.0611 | — | 0.1161 |

Polyethylene compositions were prepared by blending a polyethylene homopolymer with an additive package at loadings as shown in Table 5. The polyethylene formulations are melt compounded in a single screw extruder at 190° C. under nitrogen. The % amounts shown in the table are % by weight of the overall polyethylene composition.

TABLE 5

| | PP18 | DVS391 | A240 | ZnO | Total |
|---|---|---|---|---|---|
| Example | (%) | (%) | (%) | (%) | (%) |
| 16 | 0.10 | 0.14 | — | 0.05 | 0.29 |
| 17 | 0.10 | 0.12 | — | 0.05 | 0.27 |
| 18 | 0.10 | 0.10 | — | 0.05 | 0.25 |
| 19 (Comp) | 0.10 | — | 0.15 | 0.05 | 0.30 |

Example 19 comprises tris(2,4-di-t-butylphenyl) phosphite and is therefore comparative.

### Colour Stability

Each of the polymeric compositions referenced in Tables 2 to 5 were multi-passed through an extruder at 260° C. (for Examples 1 to 15) or 280° C. (for Examples 16 to 19) under air. Extrusion experiments were performed on a 25 mm SS Brabender™ Extruder. After each pass through the extruder the polymer sample was cooled in a water bath, dried and chipped to give pellets which were analysed and subjected to the same procedure again. The discolouration of the compositions was measured in terms of Yellowness Index using a colorimeter (Xrite™ Color i7) according to YI ASTM D1925. Each YI measurement is the average of 4 measured values. YI values were taken following compounding (pass 0) and after passes 1, 3 and 5. The lower the YI value, the less discolouration of the composition. The results are shown in Table 6.

TABLE 6

YI Value

| Example | Pass 0 | Pass 1 | Pass 3 | Pass 5 |
|---|---|---|---|---|
| 1 (Comp) | 4.44 | 7.585 | 9.504 | 11.215 |
| 2 | 2.695 | 4.313 | 6.28 | 7.648 |
| 3 | 3.067 | 4.997 | 6.942 | 8.169 |
| 4 (Comp) | 1.522 | 2.254 | 3.548 | 4.604 |
| 5 | 1.253 | 1.905 | 3.429 | 4.859 |
| 6 | 1.421 | 2.029 | 3.154 | 4.32 |
| 7 | 0.51 | 1.36 | 2.62 | 3.78 |
| 8 (Comp) | 0.62 | 1.53 | 3.12 | 4.97 |
| 9 (Comp) | 0.59 | 1.65 | 3.62 | 4.93 |
| 10 (Comp) | 0.47 | 1.61 | 3.38 | 4.28 |
| 11 (Comp) | 0.32 | 1.39 | 3.34 | 3.97 |
| 12 (Comp) | 0.33 | 1.32 | 2.89 | 4.24 |
| 13 (Comp) | 0.52 | 1.27 | 2.73 | 3.84 |
| 14 | −0.03 | 0.99 | 2.94 | 4.48 |
| 15 | −0.29 | 0.78 | 2.18 | 2.68 |
| 16 | −4.241 | −3.910 | −3.611 | −3.067 |
| 17 | −4.218 | −3.867 | −3.450 | −2.809 |
| 18 | −4.204 | −3.836 | −3.298 | −2.738 |
| 19 (Comp) | −4.097 | −3.422 | −2.587 | −1.853 |

From the results it can be seen that the polymeric compositions stabilised with the antidegradant blends in accordance with the present invention (Examples 2, 3, 5 to 7 and 14 to 18) show comparable or less discolouration than the polymeric compositions stabilised with the comparative antidegradant blends (Examples 1, 4, 8 to 13 and 19).

It can also be seen that the polymeric composition stabilised with the antidegradant blend comprising sodium hypophosphite (Example 15) shows significantly less discolouration than the polymeric composition stabilised with the equivalent antidegradant blend without sodium hypophosphite (Example 14).

### Gas Fading

The gas-fading of the polymeric compositions of Examples 1 to 13 and 16 to 19 was measured as set forth by AATCC 23 at a temperature of 60° C. The discolouration of the polymeric compositions was measured in terms of Yellowness Index using a colorimeter (Xrite™ Color i7) according to YI ASTM D1925. The results are shown in Tables 7 to 9.

TABLE 7

| | YI Value | | | | | |
|---|---|---|---|---|---|---|
| | 0 | 4 | 11 | 14 | 18 | 21 |
| Example | days | days | days | days | days | days |
| 1 (Comp) | 7.585 | 9.199 | 11.618 | 12.322 | 12.857 | 13.214 |
| 2 | 4.313 | 5.742 | 8.223 | 9.115 | 9.898 | 10.413 |
| 3 | 4.997 | 7.016 | 9.662 | 10.658 | 11.578 | 12.168 |
| 4 (Comp) | 2.254 | 3.338 | 4.882 | 5.166 | 5.484 | 5.828 |
| 5 | 1.905 | 3.021 | 4.619 | 4.869 | 5.174 | 5.514 |
| 6 | 2.029 | 3.136 | 4.622 | 4.908 | 5.201 | 5.446 |

TABLE 8

YI Value

| | 0 | 24 | 48 | 96 | 162 | 216 |
|---|---|---|---|---|---|---|
| Example | hr | hr | hr | hr | hr | hr |
| 7 | 0.62 | 6.62 | 10.15 | 12.85 | 17.34 | 17.20 |
| 8 (Comp) | 0.48 | 7.31 | 8.39 | 9.74 | 13.95 | 14.33 |
| 9 (Comp) | 0.67 | 8.64 | 10.07 | 11.54 | 17.10 | 18.71 |
| 10 (Comp) | 0.70 | 7.85 | 10.29 | 12.44 | 15.77 | 16.49 |
| 11 (Comp) | 0.39 | 7.53 | 10.64 | 13.24 | 15.51 | 16.57 |
| 12 (Comp) | 0.53 | 5.68 | 8.68 | 11.46 | 13.35 | 14.64 |
| 13 (Comp) | 0.47 | 8.17 | 10.44 | 12.80 | 15.81 | 17.49 |

TABLE 9

| | YI Value | | | | | | | |
|---|---|---|---|---|---|---|---|---|
| | 0 | 2 | 6 | 9 | 13 | 16 | 20 | 23 |
| Example | days | days | days | days | days | days | days | days |
| 16 | −3.910 | −2.714 | −0.281 | 1.185 | 2.534 | 2.968 | 3.508 | 4.849 |
| 17 | −3.867 | −2.519 | 0.029 | 1.683 | 3.143 | 3.527 | 4.245 | 5.696 |
| 18 | −3.836 | −2.180 | 0.581 | 2.356 | 3.963 | 4.325 | 5.258 | 6.743 |
| 19 (Comp) | −3.422 | −2.050 | 0.104 | 1.434 | 2.731 | 2.843 | 3.510 | 4.802 |

From the results it can be seen that the polymeric compositions stabilised with the antidegradant blends in accordance with the present invention (Examples 2, 3, 5, 6, 7 and 16 to 18) show comparable or less discolouration than the polymeric compositions stabilised with the comparative antidegradant blends (Examples 1, 4, 8 to 13 and 19).

### Melt Flow Rate

The melt flow rate of the polymeric composition of Examples 1 to 19 were determined following compounding (pass 0) and after pass 5 (and additionally after pass 1 and pass 3 for Examples 1 to 7 and 16 to 19), using a CEAST™ 7026 Melt Flow Tester according to standard test method ASTM D1238 with a temperature of 190° C., a 2.16 kg weight and a 2.095 mm die. An increase in the melt flow rate is indicative of unfavourable degradation of the sample, because it is desirable for the properties of the polymeric composition to be maintained, rather than changed, on processing. The results are shown in Table 10.

TABLE 10

Melt Flow Rate (g/10 min)

| Example | Pass 0 | Pass 1 | Pass 3 | Pass 5 |
|---|---|---|---|---|
| 1 (Comp) | 13.79 | 15.76 | 17.94 | 20.41 |
| 2 | 13.87 | 15.24 | 17.34 | 19.36 |
| 3 | 13.956 | 15.25 | 17.271 | 18.578 |
| 4 (Comp) | 12.352 | 14.294 | 17.780 | 20.935 |
| 5 | 12.587 | 14.159 | 15.547 | 23.699 |
| 6 | 12.370 | 14.998 | 21.212 | 26.250 |
| 7 | 7.23 | — | — | 12.87 |
| 8 (Comp) | 7.15 | — | — | 10.82 |
| 9 (Comp) | 7.27 | — | — | 13.29 |
| 10 (Comp) | 7.49 | — | — | 13.67 |
| 11 (Comp) | 7.63 | — | — | 13.98 |
| 12 (Comp) | 7.57 | — | — | 11.51 |
| 13 (Comp) | 7.14 | — | — | 14.01 |
| 14 | 7.38 | — | — | 17.35 |
| 15 | 7.78 | — | — | 15.59 |
| 16 | 3.710 | 3.677 | 3.577 | 3.427 |
| 17 | 3.733 | 3.671 | 3.507 | 3.322 |
| 18 | 3.706 | 3.649 | 3.433 | 3.220 |
| 19 (Comp) | 3.664 | 3.631 | 3.487 | 3.299 |

From the results it can be seen that the polymeric compositions stabilised with the antidegradant blends in accordance with the present invention (Examples 2, 3, 5 to 7 and 14 to 18) retained melt flow rate similarly to the polymeric compositions stabilised with the comparative antidegradant blends (Examples 1, 4, 8 to 13 and 19).

It can also be seen that the polymeric composition stabilised with the antidegradant blend comprising sodium hypophosphite (Example 15) retained melt flow rate better than the polymeric composition stabilised with the equivalent antidegradant blend without sodium hypophosphite (Example 14).

### FIGURES

FIG. 1 depicts a graph of melt flow rate comparison of a polypropylene homopolymer compounded with the additives of Examples 1, 2 and 3 at compounding and after first, third and fifth multipass at 260° C. The results demonstrate comparable melt flow protection at equal phosphorus loading.

FIG. 2 depicts a graph of colour comparison (yellowing by YI) of a polypropylene homopolymer compounded with the additives of Examples 1, 2 and 3. TOTBP shows better performance than A240.

FIG. 3 depicts a graph of gas fading performance of a polypropylene homopolymer compounded with the additives of Examples 1, 2 and 3. TOTBP shows better performance than A240.

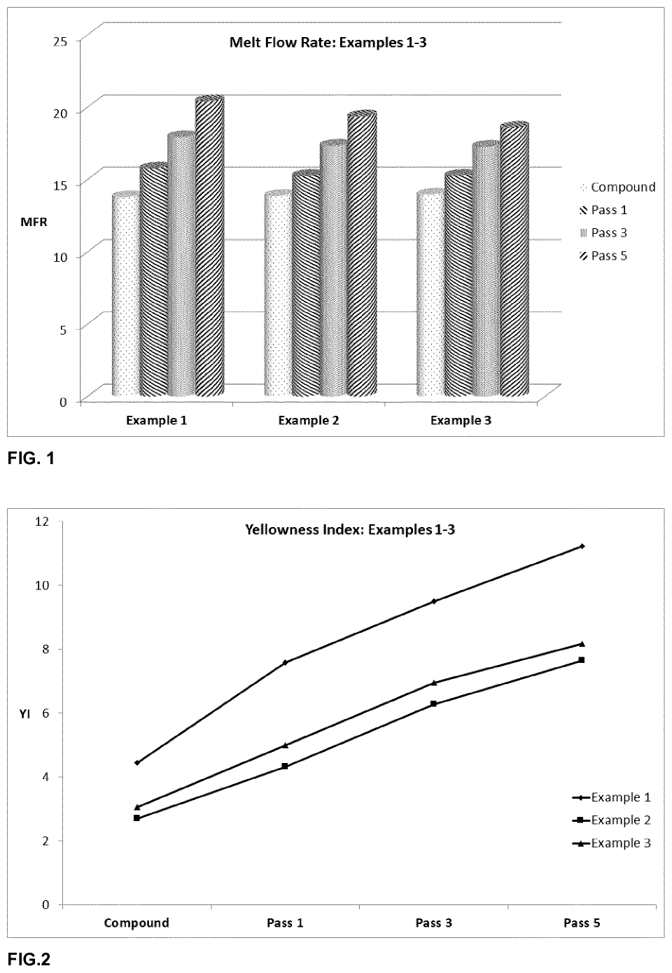

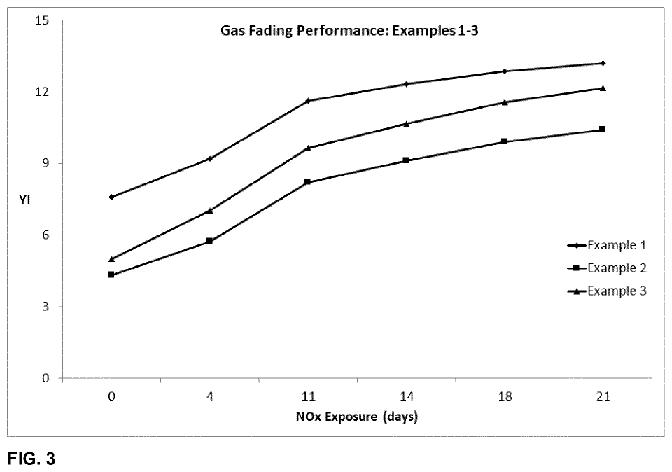

### EXAMPLES 20 TO 22 (METHODS OF PREPARATION)

### Standard Procedure (Example 20—Comparative)

### Equipment

A 1 l jacketed vessel equipped with an overhead stirrer, condenser, nitrogen line and addition port. The vessel is vented via the condenser to a caustic scrubber.

### Method

2-t-butyl phenol was dried in the lab before use.

2-t-butyl phenol (100 g; 0.666 mol; 1.00 eq) was charged to an inerted vessel at 100° C. and dimethyl-laurylamine (1.58 g; 7.4 mmol, 0.011 eq) was charged. PCl₃ (29.9 g, 0.22 mol, 0.33 eq) was charged over 1.5 hours, while warming the reaction mass to 180° C. The reaction mass was then degassed under vacuum at 180° C. for 3 hours.

| Property | Data |
|---|---|
| Mass yield | Not determined |
| Phosphite (³¹P NMR) | 97.11% |
| De-butylated phosphite (³¹P NMR) | 2.89% |
| Phosphates (³¹P NMR) | n/d |
| 1H acid (³¹P NMR) | n/d |

The reaction mass temperature was adjusted to 155° C. and run into iso-propanol (300 ml), with stirring and further isopropanol (100 ml) was added. This was cooled to 5-10° C. and held for 1 hour. After filtration the filter cake was washed with further isopropanol (3×50 ml). The product was then dried under vacuum.

| Property | Data |
|---|---|
| Mass yield | 73.5 g (69.8% from TBP) |
| Phosphite (HPLC area %) | 99.55% |
| De-butylated phosphite (HPLC area %) | 0.39% |
| Phosphates (HPLC area %) | n/d |
| 1H acid (HPLC area %) | n/d |
| TBP (HPLC area %) | 0.02% |

### Procedure Based on DE 2490548 (Example 21—Comparative)

### Method

2-t-butyl phenol (100.17 g; 0.67 mol) was charged to a jacket flask and warmed to 50° C. with stirring. Phosphorous trichloride (25.5 g; 0.19 mol) was added dropwise over 1 hour to the stirred reaction mass. The temperature was increased to approximately 150° C. over 1 hour and held at this temperature for a total of 5 hours. Vacuum was then applied using an oil pump and 28.4 g (0.19 mol) 2-t-butyl phenol was collected. A sample of the crude reaction product had the following properties:

| Property | Data |
|---|---|
| Phosphite (³¹P NMR) | 74.3% |
| De-butylated phosphite (³¹P NMR) | 19.9% |
| Phosphates (³¹P NMR) | n/d |
| 1H acid (³¹P NMR)* | 1.2% |

*2H acid also present at 4.5%

The temperature was adjusted to ˜90° C. and isopropanol (120 g) charged in one portion.

Crystallisation started at 20° C. and was then cooled to 10° C. before filtration, washing and drying.

In order for the results to be comparable to those of the procedure of the invention (Example 22), the recrystallisation step was not carried out—the procedure of the invention involves only a single crystallisation.

A sample of the isolated reaction product had the following properties:

| Property | Data |
|---|---|
| Mass yield | 29.3 g (0.061 mol; |
| | 32.2% th based on PCl₃) |
| Phosphite (HPLC area %) | 97.2% |
| De-butylated phosphite (HPLC area %) | 2.0% |
| Phosphates (HPLC area %) | n/d |
| 1H acid (HPLC area %) | <0.1 |
| 2-TBP (HPLC area %) | 0.1 |

### EXAMPLE 22—PROCEDURE OF THE INVENTION

### Method

PCl₃ (34.0 g; 0.248 mol; 0.358 eq) was charged to a thoroughly inerted vessel and heated to ˜50° C., with the condenser set at 0.4° C. N,N-di-octylamine (1.65 g; 6.83 mmol; 0.0098 eq) was charged to 2-t-butyl phenol (104.2 g; 0.694 mol; 1.00 eq). The phenol/catalyst mix was then charged sub-surface over 1 hour maintaining the temperature at 50-58° C. At the end of the addition, the temperature was raised to 140° C. over 1 hour and then vacuum applied. The HCl off gas was scrubbed as it was evolved. The temperature was then raised to 183° C. over 30 minutes and the batch held for 3 hours prior to cooling.

| Property | Data |
|---|---|
| Mass yield | 109.0 g (98.9% based on TBP) |
| Phosphite (³¹P NMR) | 94.7% |
| De-butylated phosphite (³¹P NMR) | 0.22% |
| Phosphates (³¹P NMR) | n/d |
| 1H acid (³¹P NMR) | 3.8% |

Isopropanol (94.5 g) was charged to an inerted vessel and heated to 30° C. Crude molten TOTBP (59.1 g) was the added over ˜5 minutes maintaining the reaction mass temperature below 50° C. The reaction mass was then cooled, with stirring to 10° C. over ˜75 minutes. The reaction mass was filtered and the solids washed with cold isopropanol (50 g), before drying under vacuum.

| Property | Data |
|---|---|
| Mass yield | 49.8 g (84.3% recovery; |
| | 83.3% from TBP) |
| Phosphite (HPLC area %) | 99.40% |
| De-butylated phosphite (HPLC area %) | n/d |
| Phosphates (HPLC area %) | 0.40% |
| 1H acid (HPLC area %) | 0.03% |
| TBP (HPLC area %) | 0.15% |

It will be seen that the process of the invention gives rise to significantly less debutylation than the prior art processes, allowing the production of tris(2-t-butylphenyl) phosphite in the absence of di(2-t-butylphenyl) monophenyl phosphite.

In addition, it will be seen that the process of the invention gives rise to a significantly greater mass yield than the prior art processes and a much higher purity TOTBP product.

Without wishing to be bound by any such theory, it is believed that adding 2-t-butyl phenol to phosphorus trichloride (i.e. a reverse addition) and carrying out the addition in the presence of a catalyst, contributes to the improvements seen over the prior art processes. In the DE 2490548 procedure, for example, phosphorus trichloride is added to 2-t-butyl phenol (i.e. a standard addition) and no catalyst is used. A recrystallisation step is required in the DE 2490548 procedure to improve the purity of the product, whereas the procedure of the invention requires only a single crystallisation.

1-25. (canceled)

26. A stabilizing antioxidative composition, comprising tris(2-t-butylphenyl) phosphite, with the proviso that the composition does not contain any tris(2,4-di-t-butylphenyl) phosphite.

27. The stabilizing antioxidative composition according to claim 26, with the proviso that the composition does not contain any arylphosphite having a t-butyl group in the para-position, with respect to the phosphite group.

28. The stabilizing antioxidative composition according to claim 27, with the proviso that the composition does not contain any arylphosphite having an alkyl group in the para-position, with respect to the phosphite group.

29. The stabilizing antioxidative composition according to claim 26, with the proviso that the composition does not contain any di(2-t-butylphenyl) monophenyl phosphite.

30. A stabilizing antioxidative composition comprising tris(2-t-butylphenyl) phosphite, prepared by adding 2-t-butyl phenol to a phosphorus trihalide.

31. The stabilizing antioxidative composition according to claim 30, with the proviso that the composition does not contain any di(2-t-butylphenyl) monophenyl phosphite.

32. The stabilizing antioxidative composition according to claim 30, wherein the 2-t-butyl phenol is added to the phosphorus trihalide by subsurface addition.

33. The stabilizing antioxidative composition according to claim 30, wherein the addition of 2-t-butyl phenol to the phosphorus trihalide is conducted stepwise or continuously, such that 2-t-butyl phenol is added to a bulk quantity of the phosphorus trihalide.

34. The stabilizing antioxidative composition according to claim 30, wherein the reaction temperature during addition of the 2-t-butyl phenol to the phosphorus trihalide is maintained at or below 150° C. for at least a portion of the period of time during which the 2-t-butyl phenol is added to the phosphorus trihalide.

35. The stabilizing antioxidative composition according to claim 30, wherein the addition of the 2-t-butyl phenol to the phosphorus trihalide is conducted in the presence of a catalyst.

36. The stabilizing antioxidative composition according to claim 35,
wherein the catalyst has the formula NR¹R²R³, wherein R¹ is H or an optionally substituted hydrocarbyl group, and R² and R³, which may be the same or different, are both optionally substituted hydrocarbyl groups of carbon chain length >1; or
wherein the catalyst has a cation and an anion, the cation having the formula N⁺R¹R²R³R⁴, wherein R¹ to R⁴, which may be the same or different, are optionally substituted hydrocarbyl groups having >1 carbon atoms.

37. Tris(2-t-butylphenyl) phosphite having a purity of at least about 98%.

38. The tris(2-t-butylphenyl) phosphite according to claim 37, having a purity of at least about 99%.

39. The tris(2-t-butylphenyl) phosphite according to claim 37, prepared by a single chemical reaction, followed by a single crystallization step.

40. The tris(2-t-butylphenyl) phosphite according to claim 39, wherein the single chemical reaction is adding 2-t-butyl phenol to a phosphorus trihalide.

41. A stabilizing antioxidative composition comprising the tris(2-t-butylphenyl) phosphite according to claim 37.

42. An antidegradant blend comprising the stabilizing antioxidative composition according claim 26.

43. The antidegradant blend according to claim 42, further comprising one or more of the following:
i. a phenolic antioxidant;
ii. a further organic phosphite antioxidant other than:
x. tris(2,4-di-t-butylphenyl) phosphite;
y. any arylphosphite having a t-butyl group in the para-position with respect to the phosphite group; and/or
z. any arylphosphite having an alkyl group in the para-position with respect to the phosphite group;
iii. a sulphur-containing antioxidant; and/or
iv. an aminic antioxidant.

44. The antidegradant blend according to claim 42, further comprising one or more of the following:
i. a buffering agent having the capacity to buffer in an aqueous solution at a pH range from 4 to 8;
ii. a metal carboxylate;
iii. an inorganic antioxidant or reducing agent; and/or
iv. an inorganic acid scavenger.

45. The antidegradant blend according to claim 44, comprising:
a. a buffering agent selected from one or more metal phosphates and/or one or more metal pyrophosphates;
b. a buffering agent selected from the one or more amino acids and/or the alkali metal salts thereof;
c. a metal carboxylate selected from the group consisting of a metal stearate, a metal lactate, a metal benzoate, and combinations thereof;
d. a secondary inorganic antioxidant selected the group consisting of a metal hypophosphite, a metal thiosulphate, a metal bisulphite, a metal metabisulphite, a metal hydrosulphite, and combinations thereof; and/or
e. an inorganic acid scavenger selected from the group consisting of metal oxides, metal hydroxides, metal carbonates, metal salts, hydrotalcite-like compounds, and combinations thereof.

46. The antidegradant blend according to claim 42, further comprising one or more of the following:
a. an organic phosphite antioxidant other than TOTBP selected from the group consisting of distearylpentaerythritol diphosphite; tris(dipropyleneglycol) phosphite, C₁₈H₃₉O₉P; poly(dipropyleneglycol) phenyl phosphite; diphenyl isodecyl phosphite, C₂₂H₃₁O₃P; phenyl diisodecyl phosphite; heptakis (dipropyleneglycol) triphosphite; and combinations thereof.
b. a semi-hindered phenolic antioxidants selected from the group consisting of 1,3,5-tris(4-tert-butyl-3-hydroxy-2,6-dimethylbenzyl)-1,3,5-triazine-2,4,6-(1H, 3H, 5H)-trione; triethyleneglycol-bis-[3-(3-t-butyl-4-hydroxy-5-methylphenyl)propionate]; the butylated reaction product of p-cresol and dicyclopentadiene; 2,2′-methylenebis(6-t-butyl-4-methylphenol); and combinations thereof;
c. a hindered phenolic antioxidants selected from tetrakismethylene(3,5-di-t-butyl-4-hydroxyhydrocinnamate) methane; 2,2′thiodiethylene bis[3(3,5-di-t-butyl-4-hydroxyphenyl)propionate]; C13-C15 linear and branched alkyl esters of 3-(3′5′-di-t-butyl-4′-hydroxyphenyl) propionic acid; octadecyl 3-(3′,5′-di-t-butyl-4′-hydroxyphenyl) propionate; 1,3,5-tris(3,5-di-t-butyl-4-hydroxybenzyl) isocyanurate; 1,3,5-trimethyl-2,4,6-tris(3,5-di-t-butyl-4-hydroxybenzyl)benzene; N,N′-hexamethylenebis[3-(3,5-di-t-butyl-4-hydroxyphenyl)propionamide]; 1,2-bis(3,5-di-t-butyl-4-hydroxyhydrocinnamoyl)hydrazine; C9-C11 linear and branched alkyl esters of 3-(3′,5′-di-t-butyl-4′-hydroxyphenyl)propionic acid; 2,2′-ethylidenebis[4,6-di-t-butylphenol]; butylated hydroxytoluene; and combinations thereof;
d. sulphur-containing antioxidants selected from the group consisting of dilauryl-3,3′-thiodipropionate; distearyl-3,3′-thiodipropionate; ditridecylthiodipropionate; pentaerythritol tetrakis (β-laurylthiopropionate); 2,2′thiodiethylene bis[3(3,5-di-t-butyl-4-hydroxyphenyl)propionate]; dimyristyl thiodipropionate; distearyl-disulfide; 4,4′-thiobis(2-tert-butyl-5-methylphenol); 2,2′-thiobis(6-t-butyl-4-methylphenol); and combinations thereof; and/or
e. aminic antioxidants selected from the group consisting of acetone diphenylamine; reaction products of diphenylamine and acetone; N,N′-diphenyl-p-phenylenediamine; benzeneamine, N-phenyl-, reaction products with 2,4,4-trimethylpentene; bis[4-(2-phenyl-2-propyl)phenyl]amine; poly(1,2-dihydro-2,2,4-trimethylquinoline); dioctyldiphenylamine; N,N-bis-(1,4-dimethylpentyl)-p-phenylenediamine; 1,4-benzenediamine, N,N′-mixed phenyl and tolyl derivatives; N,N′,N″-tris[4-[(1,4-dimethylpentyl)amino]phenyl]-1,3,5-triazine-2,4,6-triamine; N-isopropyl-N′-phenyl-1,4-phenylenediamine; diphenylamine; (1,3-dimethylbutyl)-N′-phenyl-p-phenylenediamine; poly(4-hydroxy-2,2,6,6-tetramethyl-1-piperidine ethanol-alt-1,4-butanedioic acid); bis(2,2,6,6-tetramethyl-4-piperidyl) sebacate; bis(1,2,2,6,6-pentamethyl-4-piperidyl) sebacate; poly[[6-[(1,1,3,3-tetramethylbutyl)amino]-1,3,5-triazine-2,4-diyl][2,2,6,6-tetramethyl-4-piperidiyl)imino]-1,6-hexanediyl[(2,2,6,6-tetramethyl-4-piperidiyl)imino]]); 1,5,8,12-tetrakis[4,6-bis(N-butyl-N-1,2,2,6,6-pentamethyl-4-piperidylamino)-1,3,5-triazin-2-yl]-1,5,8,12-tetraazadodecane; and combinations thereof.
